(19) United States
(12) Patent Application Publication
(10) Pub. No.: US 2018/0376443 A1
(43) Pub. Date: Dec. 27, 2018

(54) Methods And Apparatus Of Location Reporting Relations Between Wi-Fi Calling Capability And Cellular Network Registration

(71) Applicant: MediaTek Singapore Pte. Ltd., Singapore (SG)

(72) Inventors: Sergei Maksimov, St. Petersburg (RU); Kristian Alexander Lappalainen, Oulu (FI); Mohamed Abdelrazek El-Saidny, San Jose, CA (US); Nader Adel Youssef Atteya, Dubai (AE)

(21) Appl. No.: 16/006,960

(22) Filed: Jun. 13, 2018

Related U.S. Application Data
(60) Provisional application No. 62/519,209, filed on Jun. 14, 2017.

(51) Int. Cl. H04W 60/02; H04W 8/08; H04L 29/06; H04W 48/20; H04W 48/18; H04W 4/20

(52) U.S. Cl. CPC H04W 60/02; H04W 8/08; H04W 4/20; H04W 48/20; H04W 48/18; H04L 65/1006

(57) ABSTRACT

Various solutions for location reporting relations between Wi-Fi calling capability and cellular network registration are described. A processor of an apparatus detects that a subscriber identity associated with the apparatus is out of network coverage. The processor then obtains an identity (ID) of a last wireless network among one or more wireless networks that the apparatus camped on under the subscriber identity. The processor also reports at least the ID to a service provider. In reporting at least the ID, the processor may report the ID and at least a timestamp in a Cellular Network Information (CNI) header field of a Session Initiation Protocol (SIP) header.

### CROSS REFERENCE TO RELATED PATENT APPLICATION(S)

The present disclosure is part of a non-provisional application claiming the priority benefit of U.S. Patent Application No. 62/519,209, filed on 14 Jun. 2017, the content of which is incorporated by reference in its entirety.

### TECHNICAL FIELD

The present disclosure is generally related to mobile communications and, more particularly, to location reporting relations between Wi-Fi calling capability and cellular network registration.

### BACKGROUND

Unless otherwise indicated herein, approaches described in this section are not prior art to the claims listed below and are not admitted as prior art by inclusion in this section.

In various countries, pertinent regulatory bodies have requested user equipment (UE) vendors to provide UEs that are capable of reporting User Provided Location Identify (UPLI) for Wi-Fi calling (WFC) service. The requirement also gives high dependency on the state when a subscriber (e.g., a UE such as a smartphone or a mobile communication device) is not camped on its Home Public Land Mobile Network (HPLMN) cell to extend WFC service beyond the operator's cellular network coverage. The required field in the Session Initiation Protocol (SIP) header for the report of UPLI is Cellular Network Information (CNI) header field.

CNI header field is introduced in the 3^{rd} Generation Partnership Project (3GPP) specification TS 24.229 Release 14. It is specified that a User Agent (UA) supporting one or more cellular radio access technologies (e.g., E-UTRAN) but using a non-cellular Internet Protocol connectivity access network (IP-CAN) to access the IP Multimedia (IM) Core Network (CN) subsystem can use the CNI header field to “relay information to its service provider about the radio cell identity of the cellular radio access network the UE most recently camped on.” For example, a UE making an emergency call using the Evolved Packet Core (EPC) via an untrusted Wireless Local Access Network (WLAN) as IP-CAN to access the IM CN subsystem can use the CNI header field to convey location information to its service provider. The requirement of reporting the radio cell identity of the cellular radio access network on which the UE most recently camped means that, once the UE moved to a location outside the coverage area of HPLMN and is unable to find a suitable cell to camp on, the location that can be reported is only the last one. However, after expiry of the time limit for cell-info-age defined by the agency, the WFC would be restricted for such subscriber.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions, schemes, techniques, methods and apparatuses that address the aforementioned issue pertaining to restricted coverage or limited availability of WFC service after expiry of the time limit for cell-info-age defined by the agency. In particular, the present disclosure proposes several schemes that aim to extend the WFC service beyond the operator's cellular network coverage after expiry of the time limit for cell-info-age defined by the agency.

In one aspect, a method may involve a processor of an apparatus detecting that a subscriber identity associated with the apparatus is out of network coverage. The method may also involve the processor obtaining an identity (ID) of a last wireless network among one or more wireless networks that the apparatus camped on under the subscriber identity. The method may further involve the processor reporting at least the ID to a service provider.

In one aspect, a method may involve a processor of an apparatus detecting that a first subscriber identity associated with the apparatus is out of coverage of a first wireless network. The method may also involve the processor determining whether a second subscriber identity associated with the apparatus is within coverage of a second wireless network. The method may further involve the processor obtaining an ID of the second wireless network or another wireless network. The method may additionally involve the processor reporting at least the ID to a service provider.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example first scheme in accordance with an implementation of the present disclosure.

FIG. 2 is a diagram of an example second scheme in accordance with an implementation of the present disclosure.

FIG. 3 is a diagram of an example scenario in which example second scheme may be implemented in accordance with the present disclosure.

FIG. 4 is a diagram of an example third scheme in accordance with an implementation of the present disclosure.

FIG. 5 is a diagram of an example system in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to uplink transmission skipping with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

Based on the 3GPP specification, some carriers and regulators around the world have set requirements on location reporting for WFC-enabled UEs. For instance, in some countries it is required that CNI and P-Access-Network-Info (P-ANI) are mandatory headers to carry location information and that timestamp is mandatory. Moreover, the headers are required to be transmitted in all scenarios (whether cellular communication is available or not available). In some cases, after the timestamp of the location information exceeds two hours the service will be restricted. Some countries require reporting of both the last location in cell global identity (CGI) P-ANI format and global positioning system (GPS) latitude and longitude coordinates. In some cases, however, a UE might not have a last cell identity (ID) after time out. Some countries may impose a requirement that a UE must report a valid cell ID in SIP headers for security tracking and charging.

In view of the above, the present disclosure proposes a number of schemes pertaining to different cases or scenarios. For cases in which all networks for associated subscriber identity modules (SIMs) of a UE are out of coverage or when no SIM card is inserted in the UE, which is a single-SIM UE or a multi-SIM UE (e.g., dual SIM dual standby (DSDS)), a first scheme proposed by the present disclosure may enable the UE to find cell information (e.g., cell ID and any other required information) through a cell selection procedure in accordance with the present disclosure. For cases in which one of the SIMs of a multi-SIM UE engaged in or otherwise used for WFC (e.g., an Evolved Packet Data Gateway (ePDG)-capable SIM) is out of coverage, a second scheme proposed by the present disclosure may enable the UE to find cell information (e.g., cell ID and any other required information) through the other network (associated with the other SIM of the UE) that the UE is camped on. Moreover, a third scheme proposed by the present disclosure may enable enhanced location positioning by utilizing cell ID from multiple networks in a multi-SIM deployment with respect to multiple SIMs of a multi-SIM UE.

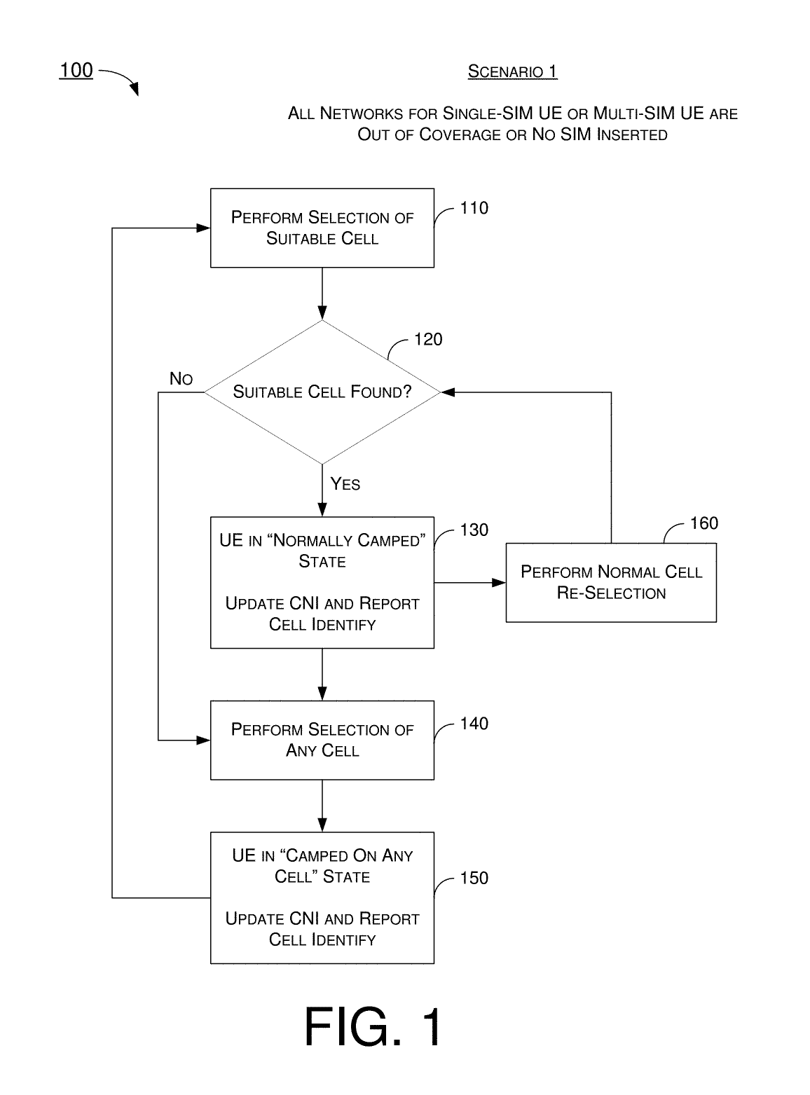

FIG. 1 illustrates an example scheme 100 in accordance with an implementation of the present disclosure. Scheme 100 may utilize a cell selection/re-selection procedure which is described per access technology in the 3GPP specification for access technologies such as, for example, Global System for Mobile communications (GSM) Enhanced Data rates for GSM Evolution (EDGE) Radio Access Network (GERAN) as specified in Chapter 3 of 3GPP TS 43.022, Universal Mobile Telecommunications Systems (UMTS) Terrestrial Radio Access Network (UTRAN) as specified in Chapter 5 of 3GPP TS 25.304, and Evolved UTRAN (EUTRAN) as specified in Chapter 5 of 3GPP TS 36.304. Scheme 100 may be utilized in a scenario (denoted as “Scenario 1” in FIG. 1) in which all networks associated with the SIM(s) of a single-SIM UE or a multi-SIM UE are out of coverage or no SIM is inserted in the UE. In such scenario, scheme 100 may enable the UE to find cell information (e.g., cell ID and any other required information) through a cell selection/re-selection procedure.

Under scheme 100, for idle mode, the result of cell selection and cell re-selection procedures may be either the UE being in a state of “camped normally” in case that a suitable cell is found or the UE being in a state of “camped on any cell” in case that there is no suitable cell. When in the state of “camped on any cell”, the UE may periodically repeat the cell selection procedure in accordance with a relevant timer.

To help improve likelihood of the location information being reported to the Lawful Interception (LI) entity, scheme 100 may involve a mechanism described below. Whenever the UE is camped normally, the relevant cell information may be embedded in the CNI header field of any SIP request or response of any SIP method. Once the UE is out of network coverage of HPLMN, the UE may be camped on any cell with service restricted and the UE may search for a suitable cell based on a timer in the UE. Whenever any cell information is obtained from the network, such cell information may be stored and embedded in the CNI header field of any SIP request or response of any SIP method with an updated timestamp. Moreover, whenever the UE has a radio contact with either a suitable cell or any cell, the UE may reset the cell-info-age timestamp.

Referring to FIG. 1, scheme 100 may involve a number of operations and/or actions performed by the UE for cell selection or re-selection as represented by one or more of blocks 110, 120, 130, 140, 150 and 160. Although illustrated as discrete blocks, various blocks of scheme 100 may be divided into additional blocks, combined into fewer blocks, or eliminated, depending on the desired implementation. Scheme 100 may be implemented by apparatus 505 described below. Scheme 100 may begin at 110.

At 110, a UE in concern may enter the cell selection process. Scheme 100 may proceed from 110 to 120.

At 120, the UE may determine whether any suitable cell is found. In an event that the UE determines that a suitable cell is found (e.g., the HPLMN for a SIM of the UE), scheme 100 may proceed from 120 to 130. Otherwise, in an event that the UE determines that no suitable cell is found, scheme 100 may proceed from 120 to 140.

At 130, the UE may enter a state of “camped normally” and camp on the suitable cell that is found (e.g., HPLMN). Under scheme 100, the UE may update a CNI header field of a SIP header with a timestamp and cell information (e.g., cell ID and any other required information) of the cell on which the UE is camped. The updating of the CNI header field may be performed immediately upon being camped on the cell or based on a timer. Eventually the UE may, in accordance with the 3GPP specification, trigger normal re-selection by performing a procedure to select a suitable cell (e.g., periodically based on a timer) or a procedure to select any cell (e.g., when the UE is out of coverage of the HPLMN). That is, scheme 100 may proceed from 130 to 140 or 160.

At 140, the UE may perform the procedure for selection of any cell in accordance with the 3GPP specification. Once any cell is found for the UE to camp on, scheme 100 may proceed from 140 to 150.

At 150, the UE may enter a state of “camped on any cell” and camp on any cell that is found. Under scheme 100, the UE may update a CNI header field of a SIP header with a timestamp and cell information (e.g., cell ID and any other required information) of the cell on which the UE is camped. The updating of the CNI header field may be performed immediately upon being camped on the cell or based on a timer. Eventually the UE may, in accordance with the 3GPP specification, trigger the procedure to select a suitable cell. That is, the UE may periodically repeat the suitable-cell selection procedure in accordance with a timer. Accordingly, scheme 100 may proceed from 150 to 110 and repeat the process of cell selection.

At 160, the UE may perform normal cell re-selection in accordance with the 3GPP specification. That is, scheme 100 may proceed from 160 to 120 to determine whether any suitable cell is found. Each time the suitable-cell selection procedure is repeated or otherwise performed, the CNI header field is updated with a timestamp and cell information (e.g., cell ID and any other required information) of the cell on which the UE is camped.

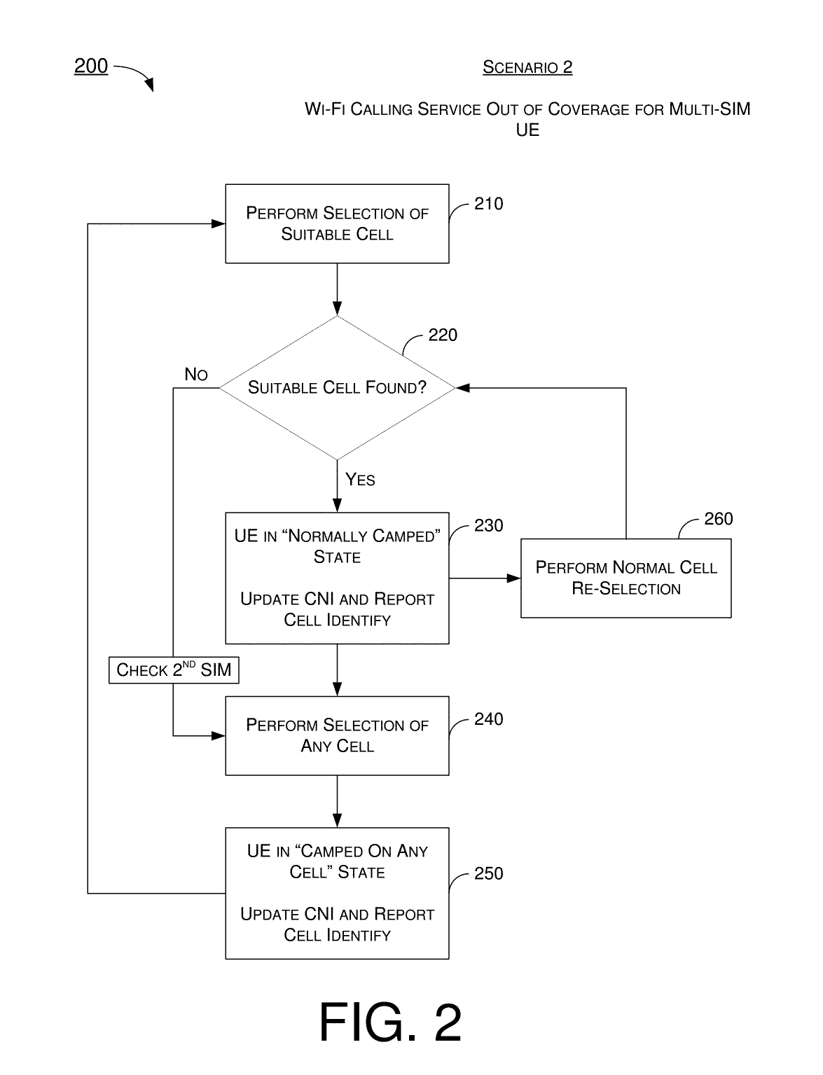

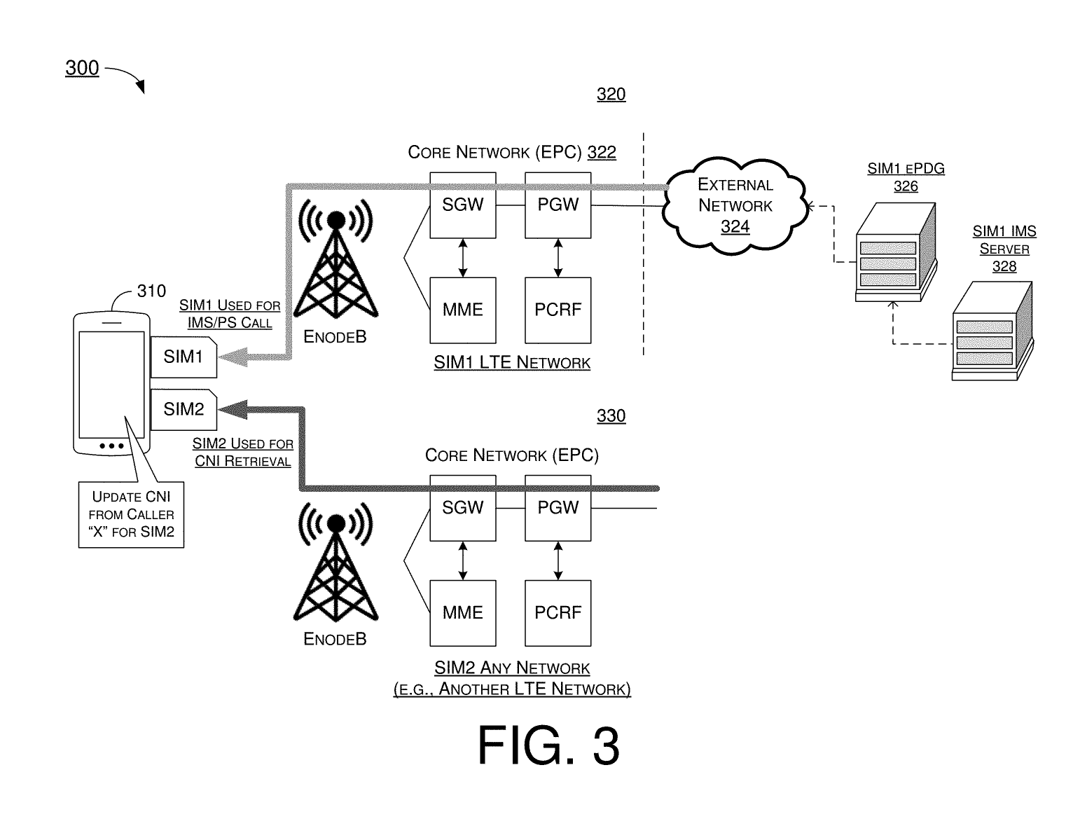

FIG. 2 illustrates an example scheme 200 in accordance with an implementation of the present disclosure. FIG. 3 illustrates an example scenario 300 in which scheme 200 may be implemented in accordance with the present disclosure. Scheme 200 may utilize a cell selection/re-selection procedure which is described per access technology in the 3GPP specification for access technologies such as, for example, GERAN, UTRAN, and EUTRAN. Scheme 200 may be utilized in a scenario (denoted as “Scenario 2” in FIG. 2) in which one of the SIMs of a multi-SIM UE engaged in or otherwise used for WFC (e.g., an ePDG-capable SIM) is out of coverage. In such scenario, scheme 200 may enable the UE to find cell information (e.g., cell ID and any other required information) through the other network (associated with the other SIM of the UE) that the UE is camped on.

For illustrative purposes and without limitation on the scope of the present disclosure, description of features, benefits and advantages of scheme 200 is provided herein with reference to scenario 300. Referring to FIG. 3, scenario 300 pertains to retrieval of CNI for a multi-SIM UE 310 which is equipped with two SIM cards (denoted as “SIM1” and “SIM2” in FIG. 3, respectively). In scenario 300, SIM1 is utilized by UE 310 for IP Multimedia Subsystem (IMS) packet-switched (PS) calls and the HPLMN for SIM1 may be a first network 320 (e.g., a Long-Term Evolution (LTE) network, which is denoted as “SIM1 LTE network” in FIG. 3). Moreover, SIM1 may be an ePDG-capable SIM. Multi-SIM UE 310 may be capable of receiving WFC service, texting and/or one or more other Internet Protocol (IP) multimedia services from SIM1 IMS server 328 via SIM1 ePDG 326, external network 324 and core network 322 of first network 320. Under scheme 200, once UE 310 is out of network coverage of first network 320, which is the HPLMN for SIM1, UE 310 may first check the status of SIM2 (e.g., whether and on which network is SIM2 camped). Whenever cell information of any cell becomes available from a second network 330 on which SIM2 is camped (denoted as “SIM2 any network” in FIG. 3, which may be another LTE network as an example), UE 310 may store the cell information (e.g., cell ID and any other required information) and embed the cell information in a CNI header field of any SIP request or response of any SIP method with an updated timestamp.

Turning now to FIG. 2, scheme 200 may involve a number of operations and/or actions performed by the UE for cell selection or re-selection as represented by one or more of blocks 210, 220, 230, 240, 250 and 260. Although illustrated as discrete blocks, various blocks of scheme 200 may be divided into additional blocks, combined into fewer blocks, or eliminated, depending on the desired implementation. Scheme 200 may be implemented by apparatus 505 described below. Scheme 200 may begin at 210.

At 210, a UE in concern may enter the cell selection process. Scheme 200 may proceed from 210 to 220.

At 220, the UE may determine whether any suitable cell is found. In an event that the UE determines that a suitable cell is found, scheme 200 may proceed from 220 to 230. Otherwise, in an event that the UE determines that no suitable cell is found (e.g., the HPLMN for a SIM of the UE), scheme 200 may proceed from 220 to 240. For instance, once the UE (e.g., UE 310) is out of network coverage of the HPLMN for one SIM card of the UE (e.g., SIM1), the UE may first check the status of another SIM card of the UE (e.g., SIM2). In particular, as scheme 200 proceeds from 220 to 240, the UE may involve or otherwise trigger a SIM2 tune-away mechanism to check whether any network corresponding to SIM2 (e.g., SIM2 network) is available.

At 230, the UE may enter a state of “camped normally” and camp on the suitable cell that is found (e.g., HPLMN). Under scheme 200, the UE may update a CNI header field of a SIP header with a timestamp and cell information (e.g., cell ID and any other required information) of the cell on which the UE is camped. The updating of the CNI header field may be performed immediately upon being camped on the cell or based on a timer. Eventually the UE may, in accordance with the 3GPP specification, trigger normal re-selection by performing a procedure to select a suitable cell (e.g., periodically based on a timer) or a procedure to select any cell (e.g., when the UE is out of coverage of the HPLMN). That is, scheme 200 may proceed from 230 to 240 or 260.

At 240, the UE may perform the procedure for selection of any cell in accordance with the 3GPP specification. In an event that a SIM2 network is available and found, the UE may retrieve the cell ID of such network and update the stored CNI. The UE may also tune back to SIM1 to update CNI to the network (e.g., over Wi-Fi connection through one or more SIP message(s)). Once any cell is found for the UE to camp on, scheme 200 may proceed from 240 to 250. In an event that no other network corresponding to SIM2 is found or otherwise available, the UE may utilize any camped cell on any PLMN from SIM1 or SIM2.

At 250, the UE may enter a state of “camped on any cell” and camp on any cell that is found. Under scheme 200, the UE may update a CNI header field of a SIP header with a timestamp and cell information (e.g., cell ID and any other required information) of the cell on which the UE is camped. The updating of the CNI header field may be performed immediately upon being camped on the cell or based on a timer. Eventually the UE may, in accordance with the 3GPP specification, trigger the procedure to select a suitable cell. That is, the UE may periodically repeat the suitable-cell selection procedure in accordance with a timer. Accordingly, scheme 200 may proceed from 250 to 210 and repeat the process of cell selection.

At 260, the UE may perform a normal cell re-selection procedure in accordance with the 3GPP specification. That is, scheme 200 may proceed from 260 to 220 to determine whether any suitable cell is found. Each time the suitable-cell selection procedure is repeated or otherwise performed, the CNI header field is updated with a timestamp and cell information (e.g., cell ID and any other required information) of the cell on which the UE is camped.

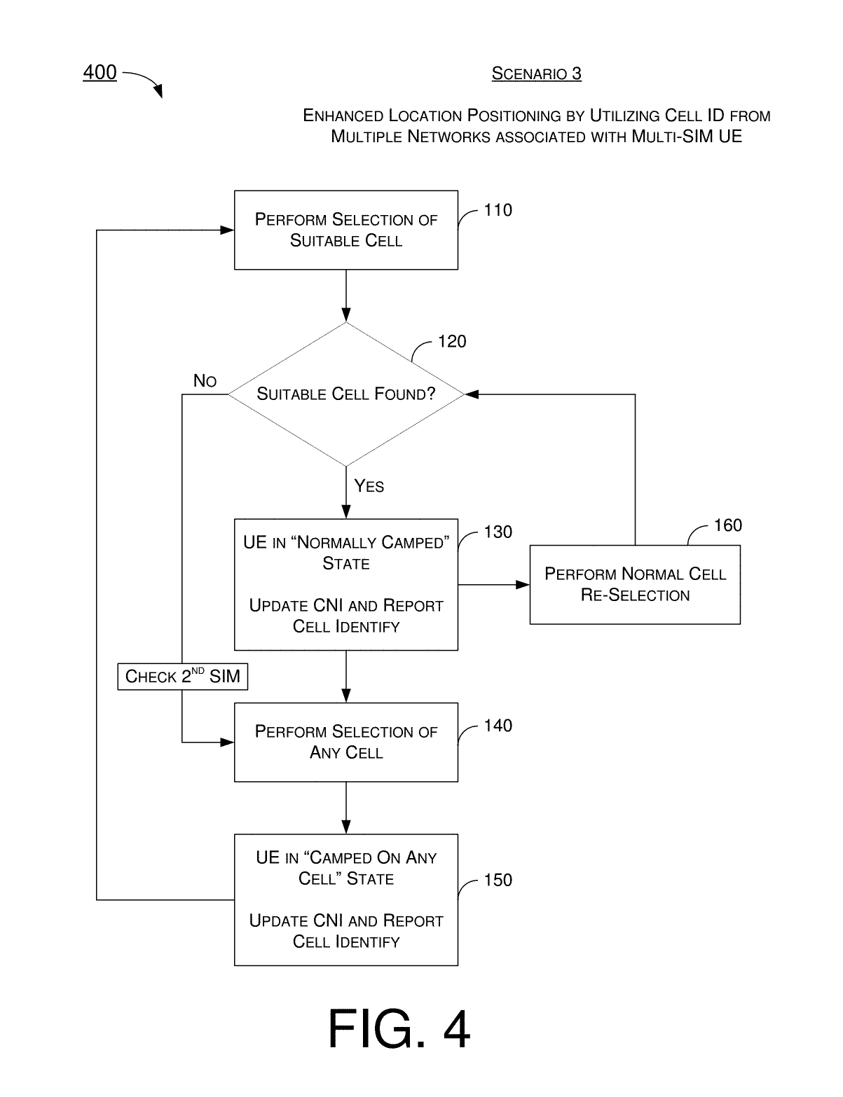

FIG. 4 illustrates an example scheme 400 in accordance with an implementation of the present disclosure. Scheme 400 may utilize a cell selection/re-selection procedure which is described per access technology in the 3GPP specification for access technologies such as, for example, GERAN, UTRAN, and EUTRAN. Scheme 400 may be utilized in a scenario (denoted as “Scenario 3” in FIG. 4) in which enhanced location positioning may be enabled by utilizing cell IDs from multiple networks in a multi-SIM deployment with respect to multiple SIMs of a multi-SIM UE. Thus, scheme 400 may also be utilized in scenario 300 described above.

Under scheme 400, a multi-SIM UE may report multiple CNI from the multiple SIMs of the UE as long as each SIM is in coverage of its respective HPLMN. In an event that any of the multiple SIMs is out of coverage, either of scheme 100 and scheme 200 may be utilized as an alternative. It is noteworthy that, although not currently adopted in the 3GPP specification, scheme 400 may be utilized for future use. This is because one, but not more than one, location instance is currently allowed per CNI header field according to 3GPP TS 24.229. When the specification is updated in a future time to allow multiple location instances (e.g., cell IDs) in a given CNI header field, scheme 400 may be implemented in multi-SIM UEs to take advantage of the benefits scheme 400 provides.

Referring to FIG. 4, scheme 400 may involve a number of operations and/or actions performed by the UE for cell selection or re-selection as represented by one or more of blocks 410, 420, 430, 440, 450 and 460. Although illustrated as discrete blocks, various blocks of scheme 400 may be divided into additional blocks, combined into fewer blocks, or eliminated, depending on the desired implementation. Scheme 400 may be implemented by apparatus 505 described below. Scheme 400 may begin at 410.

At 410, a UE in concern may enter the cell selection process. Scheme 400 may proceed from 410 to 420.

At 420, the UE may determine whether any suitable cell is found. In an event that the UE determines that a suitable cell is found, scheme 400 may proceed from 420 to 430. Otherwise, in an event that the UE determines that no suitable cell is found (e.g., the HPLMN for a SIM of the UE), scheme 400 may proceed from 420 to 440. In the context of scenario 300, once the UE (e.g., UE 310) is out of network coverage of the HPLMN for one SIM card of the UE (e.g., SIM1), the UE may first check the status of another SIM card of the UE (e.g., SIM2). In particular, as scheme 400 proceeds from 420 to 440, the UE may involve or otherwise trigger a SIM2 tune-away mechanism to check whether any network corresponding to SIM2 (e.g., SIM2 network) is available.

At 430, the UE may enter a state of “camped normally” and camp on the suitable cell that is found (e.g., HPLMN). Under scheme 400, the UE may update a CNI header field of a SIP header with a timestamp and cell information (e.g., cell IDs) of the multiple cells on which the UE is camped (e.g., first network 320 and second network 330 in scenario 300). The updating of the CNI header field may be performed immediately upon being camped on the cell or based on a timer. Eventually the UE may, in accordance with the 3GPP specification, trigger normal re-selection by performing a procedure to select a suitable cell (e.g., periodically based on a timer) or a procedure to select any cell (e.g., when the UE is out of coverage of the HPLMN). That is, scheme 400 may proceed from 430 to 440 or 460.

At 440, the UE may perform the procedure for selection of any cell in accordance with the 3GPP specification. In the context of scenario 300, in an event that a SIM2 network is available and found, the UE may retrieve the cell ID of such network and update the stored CNI. The UE may also tune back to SIM1 to update CNI to the network (e.g., over Wi-Fi connection through one or more SIP message(s)). Once any cell is found for the UE to camp on, scheme 400 may proceed from 440 to 450. In an event that no other network corresponding to SIM2 is found or otherwise available, the UE may utilize any camped cell on any PLMN from SIM1 or SIM2.

At 450, the UE may enter a state of “camped on any cell” and camp on any cell that is found. Under scheme 400, the UE may update a CNI header field of a SIP header with a timestamp and cell information (e.g., cell IDs) of the multiple cells on which the UE is camped (e.g., first network 320 and second network 330 in scenario 300). The updating of the CNI header field may be performed immediately upon being camped on the cell or based on a timer. Eventually the UE may, in accordance with the 3GPP specification, trigger the procedure to select a suitable cell. That is, the UE may periodically repeat the suitable-cell selection procedure in accordance with a timer. Accordingly, scheme 400 may proceed from 450 to 410 and repeat the process of cell selection.

At 460, the UE may perform a normal cell re-selection procedure in accordance with the 3GPP specification. That is, scheme 400 may proceed from 460 to 420 to determine whether any suitable cell is found. Each time the suitable-cell selection procedure is repeated or otherwise performed, the CNI header field is updated with a timestamp and cell information (e.g., cell IDs) of the multiple cells on which the UE is camped (e.g., first network 320 and second network 330 in scenario 300).

In view of the above, it is believed that those skilled in the art would appreciate that the proposed schemes extend the coverage area of the WFC service beyond HPLMN in countries where the regulation requirement described above is implemented. Under the first proposed scheme in accordance with the present disclosure (scheme 100), for a single-SIM UE or a multi-SIM UE while all networks are out of coverage, CNI may be retrieved from any camped cell regardless whether or not such cell is the HPLMN, and the CNI may be kept up to date based on timer(s). Under the second proposed scheme in accordance with the present disclosure (scheme 200), for a multi-SIM UE while WFC service is out of coverage for a first SIM of the UE used for WFC (e.g., ePDG-capable SIM), CNI may be retrieved from a second SIM of the UE until the ePDG-capable SIM is back in coverage. Under the third proposed scheme in accordance with the present disclosure (scheme 400), CNI may be retrieved from all SIMs (in parallel or sequentially) of a multi-SIM UE and reported back for enhanced location positioning by utilizing cell IDs from multiple networks in a multi-SIM deployment with respect to multiple SIMs of a multi-SIM UE.

### Illustrative Implementations

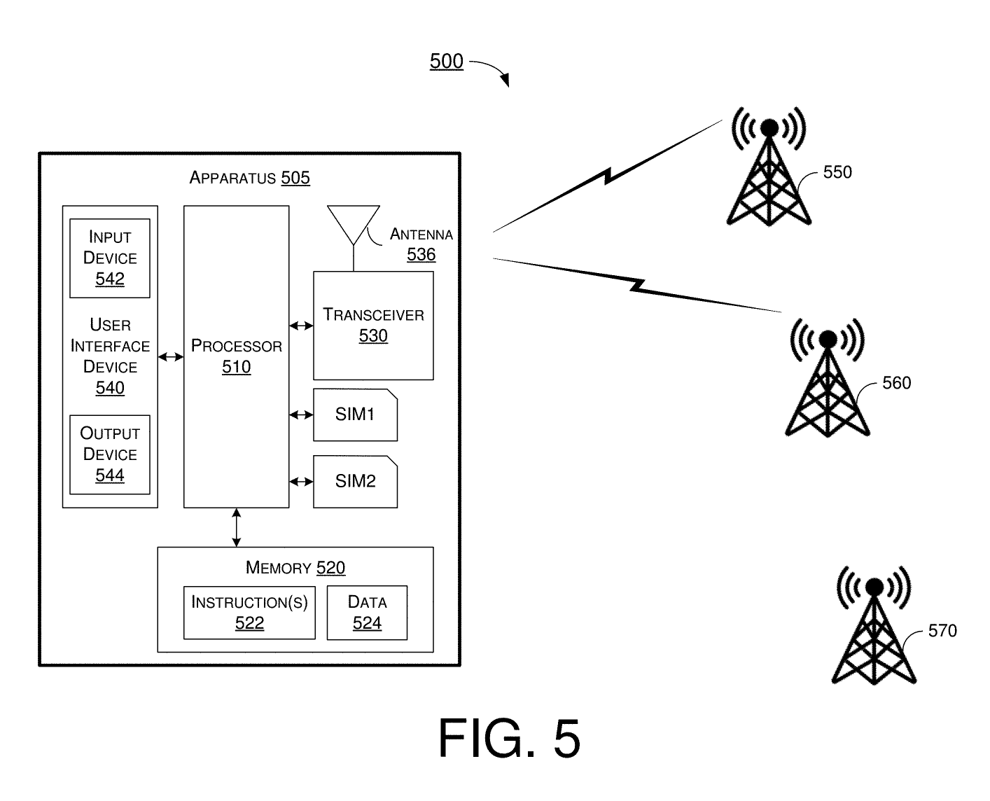

FIG. 5 illustrates an example communications system 500 in accordance with an implementation of the present disclosure. Communications systems may include an apparatus 505 and a number of wireless networks 550, 560 and 570. Apparatus 505 may perform various functions as a communication device to implement concepts, schemes, techniques, processes and methods described herein pertaining to location reporting relations between Wi-Fi calling capability and cellular network registration, including those described with respect to some or all of FIG. 1-FIG. 4 as well as processes 600 and 700 described below. More specifically, apparatus 505 may implement various aspects of the proposed concepts and schemes pertaining to location reporting relations between Wi-Fi calling capability and cellular network registration. Thus, apparatus 505 may be configured to implement each of processes 600 and 700 described below. For instance, apparatus 505 may be implemented as a UE in the context of scheme 100, scheme 200, scenario 300, scheme 400, process 600 and process 700.

Apparatus 505 may be implemented as a single-SIM UE and configured to receive or otherwise accommodate a single subscriber identity module (e.g., SIM1). Alternatively, apparatus 505 may be implemented as a multi-SIM UE and configured to receive or otherwise accommodate multiple subscriber identity modules (e.g., SIM1 and SIM2).

Apparatus 505 may be a part of an electronic apparatus which may be a communication device, a computing apparatus, a portable or mobile apparatus, or a wearable apparatus. For instance, apparatus 505 may be implemented in a Wi-Fi access point, a smartphone, a smartwatch, a smart bracelet, a smart necklace, a personal digital assistant, or a computing device such as a tablet computer, a laptop computer, a notebook computer, a desktop computer, or a server. Alternatively, apparatus 505 may be implemented in the form of one or more integrated-circuit (IC) chips such as, for example and not limited to, one or more single-core processors, one or more multi-core processors, or one or more complex-instruction-set-computing (CISC) processors.

Apparatus 505 may include at least some of those components shown in FIG. 5, respectively. For instance, apparatus 505 may include at least a processor 510. Additionally, apparatus 505 may include a memory 520, a transceiver 530, one or more antennas (represented by antenna 536) and a user interface (UI) device 540. In some implementations, transceiver 530 may be configured to transmit and receive data wirelessly (e.g., in compliance with one or more 3GPP standards, protocols, specifications and/or any applicable wireless protocols and standards such as LTE, LTE-Advanced and/or 5G NR).

Each of memory 520, transceiver 530 and UI device 540 may be communicatively and operably coupled to processor 510. Apparatus 505 may further include other components (e.g., power system, display device and user interface device), which are not pertinent to the proposed scheme of the present disclosure and, thus, are neither shown in FIG. 5 nor described herein in the interest of simplicity and brevity.

In some implementations, memory 520 may be a storage device configured to store one or more sets of codes, programs and/or instructions and/or data therein. In the example shown in FIG. 5, memory 520 stores one or more sets of processor-executable instructions 522 and data 524 therein. Memory 520 may be implemented by any suitable technology and may include volatile memory and/or non-volatile memory. For example, memory 520 may include a type of random access memory (RAM) such as dynamic RAM (DRAM), static RAM (SRAM), thyristor RAM (T-RAM) and/or zero-capacitor RAM (Z-RAM). Alternatively or additionally, memory 520 may include a type of read-only memory (ROM) such as mask ROM, programmable ROM (PROM), erasable programmable ROM (EPROM) and/or electrically erasable programmable ROM (EEPROM). Alternatively or additionally, memory 520 may include a type of non-volatile random-access memory (NVRAM) such as flash memory, solid-state memory, ferroelectric RAM (FeRAM), magnetoresistive RAM (MRAM) and/or phase-change memory.

In some implementations, transceiver 530 may be configured to communicate wirelessly in a single frequency band or multiple frequency bands. Transceiver 530 may include a transmitter capable of transmitting data wirelessly and a receiver capable of receiving data wirelessly. In some implementations, transceiver 530 may be capable of transmitting/modulating and receiving/demodulating data symbols as orthogonal frequency-division multiplexed (OFDM) symbols that are radiated through antenna 536.

In some implementations, UI device 540 may include an input device 542 and an output device. Input device 542 may be configured to allow a user of apparatus 505 to enter user input and commands in one or more fashions such as, for example and without limitation, mechanically, capacitively, inductively, magnetically, acoustically and optically. Output device 544 may be configured to output, present, display, play or otherwise provide information to the user in one or more fashions such as, for example and without limitation, visually and/or audibly. For instance, output device 544 may be capable of outputting information for Wi-Fi calling, texting, one or more other Internet Protocol (IP) multimedia services, or a combination thereof.

In some implementations, processor 510 may be implemented in the form of one or more single-core processors, one or more multi-core processors, or one or more CISC processors. That is, even though a singular term “a processor” is used herein to refer to processor 510, processor 510 may include multiple processors in some implementations and a single processor in other implementations in accordance with the present disclosure. In another aspect, processor 510 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 510 is a special-purpose machine specifically designed, arranged and configured to perform specific tasks including location reporting relations between Wi-Fi calling capability and cellular network registration in accordance with various implementations of the present disclosure.

Processor 510, as a special-purpose machine, may include non-generic and specially-designed hardware circuits that are designed, arranged and configured to perform specific tasks pertaining to location reporting relations between Wi-Fi calling capability and cellular network registration in accordance with various implementations of the present disclosure. In one aspect, processor 510 may execute the one or more sets of codes, programs and/or instructions 522 stored in memory 520 to perform various operations to render location reporting relations between Wi-Fi calling capability and cellular network registration in accordance with various implementations of the present disclosure.

In one aspect (e.g., with respect to scheme 100), processor 510 may detect that a subscriber identity associated with apparatus 505 is out of network coverage (e.g., network coverage of wireless network 550). Accordingly, processor 510 may obtain an I (e.g., cell ID) of a last wireless network (e.g., wireless network 560) among one or more wireless networks (e.g., wireless networks 550, 560 and 570) that apparatus 505 camped on under the subscriber identity. Processor 510 may also report, via transceiver 530, at least the ID to a service provider.

In some implementations, in reporting at least the ID, processor 510 may report the ID and at least a timestamp in a CNI header field of a SIP header.

In some implementations, in detecting that the subscriber identity associated with apparatus 505 is out of network coverage, processor 510 may detect that the subscriber identity is out of network coverage of a HPLMN.

In some implementations, in obtaining the ID of the last wireless network, processor 510 may perform a procedure to select any cell for the subscriber identity to camp on. Additionally, processor 510 may identify a wireless network of which the subscriber identity is within coverage. Moreover, processor 510 may establish a wireless connection with the wireless network to camp the subscriber identity on the wireless network. Furthermore, processor 510 may update a CNI header field of a SIP header.

In some implementations, in updating the CNI header field of the SIP header, processor 510 may update the CNI header with a cell ID of the wireless network and a timestamp.

In some implementations, processor 510 may also reset a timestamp associated with a cell-info-age parameter upon camping the subscriber identity on the wireless network.

Alternatively, processor 510 may periodically perform a procedure to select a suitable cell for the subscriber identity to camp on. In some implementations, processor 510 may also identify one other wireless network of which the subscriber identity is within coverage. Additionally, processor 510 may establish, via transceiver 530, a wireless connection with the other wireless network to camp the subscriber identity on the other wireless network. Moreover, processor 510 may update the CNI header field of another SIP header with a cell ID of the other wireless network and a timestamp. In some implementations, processor 510 may further reset a timestamp associated with a cell-info-age parameter upon camping the subscriber identity on the other wireless network.

In some implementations, processor 510 may enable a function on apparatus 505 by using data received from the service provider via transceiver 530. The function may include Wi-Fi calling, texting, one or more other IP multimedia services, or a combination thereof.

In some implementations, the last wireless network may include a cellular network. Moreover, in enabling the function on apparatus 505 by using data received from the service provider, processor 510 may receive, via transceiver 530, the data via a non-cellular network.

In one aspect (e.g., with respect to scheme 200, scenario 300 and scheme 400), processor 510 may detect that a first subscriber identity associated with apparatus 505 is out of coverage of a first wireless network (e.g., wireless network 550). Processor 510 may determine whether a second subscriber identity associated with apparatus 505 is within coverage of a second wireless network (e.g., wireless network 560). Processor 510 may also obtain an identity (e.g., cell ID) of the second wireless network or another wireless network. Processor 510 may further report, via transceiver 530, at least the ID to a service provider.

In some implementations, the first wireless network may include a HPLMN of the first subscriber identity.

In some implementations, in reporting at least the ID, processor 510 may update a CNI header field of a SIP header with the ID and at least a timestamp. Moreover, processor 510 may transmit, via transceiver 530, the SIP header to the service provider.

In some implementations, in transmitting the SIP header, processor 510 may transmit the SIP header over a Wi-Fi connection.

In some implementations, in determining whether the second subscriber identity is within coverage of the second wireless network, processor 510 may perform a number of operations. For instance, processor 510 may perform the following: (1) invoking a second SIM (e.g., SIM2) corresponding to the second subscriber identity to check availability of the second wireless network; (2) detecting that the second subscriber identity is within coverage of the second wireless network; and (3) switching to a first SIM (e.g., SIM1) corresponding to the first subscriber identity upon the determining that the second subscriber identity is within coverage of the second wireless network.

In some implementations, in determining whether the second subscriber identity is within coverage of the second wireless network, processor 510 may determine that the second wireless network is not available. Moreover, in obtaining the ID of the second wireless network or another wireless network, processor 510 may retrieve an ID of any wireless network either the first subscriber identity or the second subscriber identity previously camped on or an ID of a HPLMN of the first subscriber identity or the second subscriber identity.

In some implementations, processor 510 may also enable a function on apparatus 505 by using data received from the service provider. The function may include Wi-Fi calling, texting, one or more other IP multimedia services, or a combination thereof.

In some implementations, processor 510 may establish, via transceiver 530, a first wireless connection with a first HPLMN of the first subscriber identity to camp the first subscriber identity on the first HPLMN. Furthermore, processor 510 may establish, via transceiver 530, a second wireless connection with a second HPLMN of the second subscriber identity to camp the second subscriber identity on the second HPLMN. In some implementations, in obtaining the ID of the second wireless network or another wireless network, processor 510 may obtain a first ID of the first HPLMN and a second ID of the second HPLMN. Additionally, in reporting at least the ID, processor 510 may report the first ID and the second ID.

In some implementations, in reporting the first ID and the second ID, processor 510 may update a CNI header field of a SIP header with the first ID and the second ID and at least a timestamp. Moreover, processor 510 may transmit, via transceiver 530, the SIP header to the service provider.

### Illustrative Processes

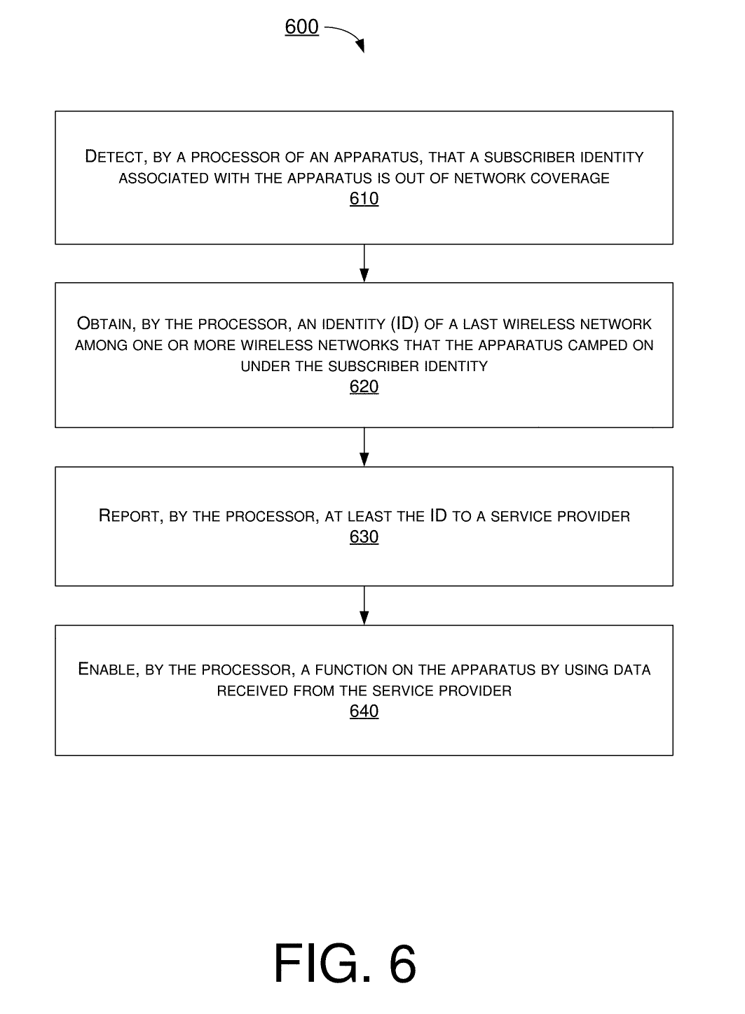

FIG. 6 illustrates an example process 600 in accordance with an implementation of the present disclosure. Process 600 may be an example implementation of scheme 100, whether partially or completely, with respect to location reporting relations between Wi-Fi calling capability and cellular network registration in accordance with the present disclosure. Process 600 may represent an aspect of implementation of features of apparatus 505. Process 600 may include one or more operations, actions, or functions as illustrated by one or more of blocks 610, 620, 630 and 640. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may be implemented by communication apparatus 505 or any suitable UE or machine type devices. Solely for illustrative purposes and without limitation, process 600 is described below in the context of communication apparatus 505. Process 600 may begin at block 610.

At 610, process 600 may involve processor 510 of apparatus 505 detecting that a subscriber identity (e.g., subscriber identity associated with SIM1) associated with apparatus 505 is out of network coverage. Process 600 may proceed from 610 to 620.

At 620, process 600 may involve processor 510 obtaining an ID of a last wireless network among one or more wireless networks that apparatus 505 camped on under the subscriber identity. Process 600 may proceed from 620 to 630.

At 630, process 600 may involve processor 510 reporting, via transceiver 530, at least the ID to a service provider (e.g., operator of SIM1 IMS server 328). Process 600 may proceed from 630 to 640.

At 640, process 600 may involve processor 510 enabling a function on apparatus 505 by using data received from the service provider. In some implementations, the function may include Wi-Fi calling, texting, one or more other Internet Protocol (IP) multimedia services, or a combination thereof.

In some implementations, the last wireless network may include a cellular network. Moreover, in enabling the function on apparatus 505 by using data received from the service provider, process 600 may involve processor 510 receiving, via transceiver 530, the data via a non-cellular network.

In some implementations, in reporting at least the ID, process 600 may involve processor 510 reporting the ID and at least a timestamp in CNI header field of a SIP header.

In some implementations, in detecting that the subscriber identity associated with apparatus 505 is out of network coverage, process 600 may involve processor 510 detecting that the subscriber identity is out of network coverage of a HPLMN.

In some implementations, in obtaining the ID of the last wireless network, process 600 may involve processor 510 performing a number of operations. For instance, process 600 may involve processor 510 performing a procedure to select any cell for the subscriber identity to camp on. Additionally, process 600 may involve processor 510 identifying a wireless network of which the subscriber identity is within coverage. Moreover, process 600 may involve processor 510 establishing, via transceiver 530, a wireless connection with the wireless network to camp the subscriber identity on the wireless network. Furthermore, process 600 may involve processor 510 updating a CNI header field of a SIP header.

In some implementations, in updating the CNI header field of the SIP header, process 600 may involve processor 510 updating the CNI header with a cell ID of the wireless network and a timestamp.

In some implementations, processor 600 may further involve processor 510 resetting a timestamp associated with a cell-info-age parameter upon camping the subscriber identity on the wireless network.

Alternatively, or additionally, process 600 may involve processor 510 periodically performing a procedure to select a suitable cell for the subscriber identity to camp on. In some implementations, process 600 may involve processor 510 identifying one other wireless network of which the subscriber identity is within coverage. Additionally, process 600 may involve processor 510 establishing, via transceiver 530, a wireless connection with the other wireless network to camp the subscriber identity on the other wireless network. Moreover, process 600 may involve processor 510 updating the CNI header field of another SIP header with a cell ID of the other wireless network and a timestamp. In some implementations, process 600 may also involve processor 510 resetting a timestamp associated with a cell-info-age parameter upon camping the subscriber identity on the other wireless network.

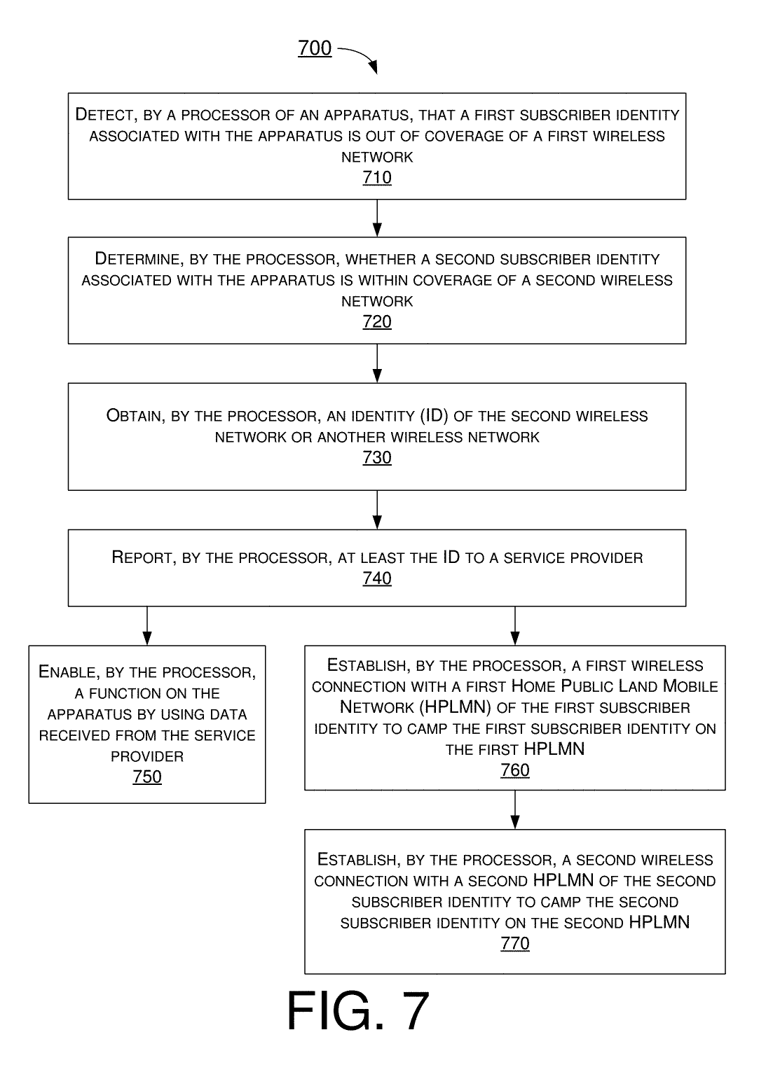

FIG. 7 illustrates an example process 700 in accordance with an implementation of the present disclosure. Process 700 may be an example implementation of scheme 200 and scheme 400, whether partially or completely, with respect to location reporting relations between Wi-Fi calling capability and cellular network registration in accordance with the present disclosure. Process 700 may represent an aspect of implementation of features of apparatus 505. Process 700 may include one or more operations, actions, or functions as illustrated by one or more of blocks 710, 720, 730, 740, 750, 760 and 770. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may be implemented by communication apparatus 505 or any suitable UE or machine type devices. Solely for illustrative purposes and without limitation, process 700 is described below in the context of communication apparatus 505. Process 700 may begin at block 710.

At 710, process 700 may involve processor 510 of apparatus 505 detecting that a first subscriber identity (e.g., subscriber identity associated with SIM1) associated with apparatus 505 is out of coverage of a first wireless network. Process 700 may proceed from 710 to 720.

At 720, process 700 may involve processor 510 determining whether a second subscriber identity (e.g., subscriber identity associated with SIM2) associated with apparatus 505 is within coverage of a second wireless network. Process 700 may proceed from 720 to 730.

At 730, process 700 may involve processor 510 obtaining an ID of the second wireless network or another wireless network. Process 700 may proceed from 730 to 740.

At 740, process 700 may involve processor 510 reporting, via transceiver 530, at least the ID to a service provider. Process 700 may proceed from 740 to 750 or 760.

At 750, process 700 may involve processor 510 enabling a function on apparatus 505 by using data received from the service provider. In some implementations, the function may include Wi-Fi calling, texting, one or more other IP multimedia services, or a combination thereof.

At 760, process 700 may involve processor 510 establishing, via transceiver 530, a first wireless connection with a first HPLMN of the first subscriber identity to camp the first subscriber identity on the first HPLMN. Process 700 may proceed from 760 to 770.

At 770, process 700 may involve processor 510 establishing, via transceiver 530, a second wireless connection with a second HPLMN of the second subscriber identity to camp the second subscriber identity on the second HPLMN. In some implementations, in obtaining the ID of the second wireless network or another wireless network, process 700 may involve processor 510 obtaining a first ID of the first HPLMN and a second ID of the second HPLMN. Additionally, in reporting at least the ID, process 700 may involve processor 510 reporting the first ID and the second ID. In some implementations, in reporting the first ID and the second ID, process 700 may involve processor 510 performing the following: (1) updating a CNI header field of a SIP header with the first ID and the second ID and at least a timestamp; and (2) transmitting, via transceiver 530, the SIP header to the service provider.

In some implementations, the first wireless network may include a HPLMN of the first subscriber identity.

In some implementations, in reporting at least the ID, process 700 may involve processor 510 updating a CNI header field of a SIP header with the ID and at least a timestamp. Moreover, process 700 may involve processor 510 transmitting, via transceiver 530, the SIP header to the service provider.

In some implementations, in transmitting the SIP header, process 700 may involve processor 510 transmitting the SIP header over a Wi-Fi connection.

In some implementations, in determining whether the second subscriber identity is within coverage of the second wireless network, process 700 may involve processor 510 performing a number of operations. For instance, process 700 may involve processor 510 invoking a second SIM (e.g., SIM2) corresponding to the second subscriber identity to check availability of the second wireless network. Moreover, process 700 may involve processor 510 detecting that the second subscriber identity is within coverage of the second wireless network. Furthermore, process 700 may involve processor 510 switching to a first SIM (e.g., SIM1) corresponding to the first subscriber identity upon the determining that the second subscriber identity is within coverage of the second wireless network.

In some implementations, in determining whether the second subscriber identity is within coverage of the second wireless network, process 700 may involve processor 510 determining that the second wireless network is not available. Moreover, in obtaining the ID of the second wireless network or another wireless network, process 700 may involve processor 510 retrieving an ID of any wireless network either the first subscriber identity or the second subscriber identity previously camped on or an ID of a HPLMN of the first subscriber identity or the second subscriber identity.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
detecting, by a processor of an apparatus, that a subscriber identity associated with the apparatus is out of network coverage;
obtaining, by the processor, an identity (ID) of a last wireless network among one or more wireless networks that the apparatus camped on under the subscriber identity; and
reporting, by the processor, at least the ID to a service provider.

2. The method of claim 1, wherein the reporting of at least the ID comprises reporting the ID and at least a timestamp in a Cellular Network Information (CNI) header field of a Session Initiation Protocol (SIP) header.

3. The method of claim 1, wherein the detecting that the subscriber identity associated with the apparatus is out of network coverage comprises detecting that the subscriber identity is out of network coverage of a Home Public Land Mobile Network (HPLMN).

4. The method of claim 1, wherein the obtaining of the ID of the last wireless network comprises:
performing a procedure to select any cell for the subscriber identity to camp on;
identifying a wireless network of which the subscriber identity is within coverage;
establishing a wireless connection with the wireless network to camp the subscriber identity on the wireless network; and
updating a Cellular Network Information (CNI) header field of a Session Initiation Protocol (SIP) header.

5. The method of claim 4, wherein the updating of the CNI header field of the SIP header comprises updating the CNI header with a cell ID of the wireless network and a timestamp.

6. The method of claim 4, further comprising:
resetting a timestamp associated with a cell-info-age parameter upon camping the subscriber identity on the wireless network.

7. The method of claim 4, further comprising:
periodically performing a procedure to select a suitable cell for the subscriber identity to camp on.

8. The method of claim 7, further comprising:
identifying one other wireless network of which the subscriber identity is within coverage;
establishing a wireless connection with the other wireless network to camp the subscriber identity on the other wireless network; and
updating the CNI header field of another SIP header with a cell ID of the other wireless network and a timestamp.

9. The method of claim 8, further comprising:
resetting a timestamp associated with a cell-info-age parameter upon camping the subscriber identity on the other wireless network.

10. The method of claim 1, further comprising:
enabling, by the processor, a function on the apparatus by using data received from the service provider,
wherein the function comprises Wi-Fi calling, texting, one or more other Internet Protocol (IP) multimedia services, or a combination thereof.

11. The method of claim 10, wherein the last wireless network comprises a cellular network, and wherein the enabling of the function on the apparatus by using data received from the service provider comprises receiving the data via a non-cellular network.

12. A method, comprising:
detecting, by a processor of an apparatus, that a first subscriber identity associated with the apparatus is out of coverage of a first wireless network;
determining, by the processor, whether a second subscriber identity associated with the apparatus is within coverage of a second wireless network;
obtaining, by the processor, an identity (ID) of the second wireless network or another wireless network; and
reporting, by the processor, at least the ID to a service provider.

13. The method of claim 12, wherein the first wireless network comprises a Home Public Land Mobile Network (HPLMN) of the first subscriber identity.

14. The method of claim 12, wherein the reporting of at least the ID comprises:
updating a Cellular Network Information (CNI) header field of a Session Initiation Protocol (SIP) header with the ID and at least a timestamp; and
transmitting the SIP header to the service provider.

15. The method of claim 14, wherein the transmitting of the SIP header comprises transmitting the SIP header over a Wi-Fi connection.

16. The method of claim 12, wherein the determining whether the second subscriber identity is within coverage of the second wireless network comprises:
invoking a second subscriber identity module (SIM) corresponding to the second subscriber identity to check availability of the second wireless network;
detecting that the second subscriber identity is within coverage of the second wireless network; and
switching to a first SIM corresponding to the first subscriber identity upon the determining that the second subscriber identity is within coverage of the second wireless network.

17. The method of claim 12, wherein the determining whether the second subscriber identity is within coverage of the second wireless network comprises determining that the second wireless network is not available, and wherein the obtaining of the ID of the second wireless network or another wireless network comprises retrieving an ID of any wireless network either the first subscriber identity or the second subscriber identity previously camped on or an ID of a Home Public Land Mobile Network (HPLMN) of the first subscriber identity or the second subscriber identity.

18. The method of claim 12, further comprising:
enabling, by the processor, a function on the apparatus by using data received from the service provider,
wherein the function comprises Wi-Fi calling, texting, one or more other Internet Protocol (IP) multimedia services, or a combination thereof.

19. The method of claim 12, further comprising:
establishing, by the processor, a first wireless connection with a first Home Public Land Mobile Network (HPLMN) of the first subscriber identity to camp the first subscriber identity on the first HPLMN; and
establishing, by the processor, a second wireless connection with a second HPLMN of the second subscriber identity to camp the second subscriber identity on the second HPLMN,
wherein the obtaining of the ID of the second wireless network or another wireless network comprises obtaining a first ID of the first HPLMN and a second ID of the second HPLMN, and
wherein the reporting of at least the ID comprises reporting the first ID and the second ID.

20. The method of claim 19, wherein the reporting of the first ID and the second ID comprises:
updating a Cellular Network Information (CNI) header field of a Session Initiation Protocol (SIP) header with the first ID and the second ID and at least a timestamp; and
transmitting the SIP header to the service provider.
